(19) United States
(12) Patent Application Publication
(10) Pub. No.: US 2015/0204277 A1
(43) Pub. Date: Jul. 23, 2015

(54) SYSTEM FOR ABSORBING GAS BY LIQUID

(71) Applicant: HELPFUL TECHNOLOGIES, INC., Deerfield Beach, FL (US)

(72) Inventors: Mark Goltsman, Rochester, NY (US); Pavel Pikul, Rochester, NY (US); Victor Gurin, Hilton, NY (US)

(21) Appl. No.: 14/598,703

(22) Filed: Jan. 16, 2015

Related U.S. Application Data
(60) Provisional application No. 61/928,635, filed on Jan. 17, 2014.

(51) Int. Cl. F02M 21/04; B01F 5/02; B01F 1/00

(52) U.S. Cl. CPC F02M 21/04; B01F 1/0005; B01F 1/0022; B01F 5/0275; B01F 2215/0085

(57) ABSTRACT

An apparatus for dissolving a gas or combination of gasses in a liquid or combination of liquids and method enabling apparatus prepare a gas/liquid solution without free gas bubbles are provided. The apparatus has of a closed space container with gas inlet port, nozzle manifold, purging gas port and liquid solution outlet port. The gas enters the container through the inlet port and a liquid enters into the container through the manifold by dispersing through nozzles. Gas saturates into dispersed liquid micro-droplets within the container, hence forming a gas/liquid solution. The gas/liquid solution flows to the bottom of the container and exits from the container through the liquid outlet port so no gas/liquid solution accumulates inside the container in the process of its making.

### CROSS-REFERENCE TO RELATED APPLICATION

This is continuation of Provisional Application No. 61/928,635 with filing date of Jan. 17, 2014, the disclosure of which is incorporated herein by reference in its entirety.

### FIELD OF THE INVENTION

The present invention relates to absorption of a gas or combination of gasses by a liquid or combination of liquids, and more specifically to treatment of liquid fuel for improvement combustion in internal combustion engines.

### BACKGROUND OF THE INVENTION

Methods and means for dissolving gases in liquids (particularly in liquid fuels for injection into an engine's combustion chamber) are known in the prior art. One method of dissolving gas at high pressure into a thin film of fuel is described in U.S. Pat. No. 7,011,048 dated Mar. 14, 2006. Another method to direct high pressure gas into the smallest possible droplets of liquid fuel by using nozzles is described in Russian Pat. 2,129,662 dated Feb. 2, 1998, U.S. Pat. No. 7,261,094 dated Aug. 28, 2007, U.S. Pat. No. 7,406,955 dated Aug. 5, 2008, U.S. Pat. No. 7,523,747 dated Apr. 28, 2009, and U.S. Pat. No. 8,037, 849 dated Oct. 18, 2011. U.S. Pat. No. 6,273,072, dated Aug. 14, 2001 discloses methods of using both nozzles and a thin film of fuel.

The apparatuses claimed by all prior art patents require special vessels used for dissolving gas in liquid. In order to perform tasks as prescribed in prior art patents, said vessels function as a fluid-containing tank in which gas-liquid solution is accumulated during gas saturation. The volume of accumulating gas-liquid solution is measured by level sensors installed within the vessel tank. Hence, a volume of accumulating gas-liquid solution is limited by the prescribed application of level sensors. In case of using gas saturation for fuels in the field of internal combustion engines, in order to satisfy engines' fuel demand, the prior art patents cause the necessity of increasing the vessel sizes and locating the vessels in a vertical mounting position, hence limiting the applicability to particular machinery types. The size and positioning of the prior art tank vessels cause critical disadvantages, especially when engines operate at maximum loads.

### SUMMARY OF THE INVENTION

In summary, the objective of the present invention is to solve the shortcomings of the prior art patents by providing the method of effectively saturating any gas or combination of gasses in any liquid or combination of liquids, and a gas absorber apparatus of tank-less continuous flow-through design that carries out said method.

Gas enters into an absorber under pressure through a gas inlet port, hence forming a gaseous medium within the absorber. Liquid is sprayed into absorber under pressure through one or more nozzles; said nozzles installed in the nozzle manifold having a separate liquid inlet port. Gas saturates into finely dispersed liquid droplets, thus forming gas-liquid solution, which straightway exits from the absorber throughout a liquid outlet port; wherein the gas-liquid solution does not accumulate in the absorber.

The absorber may also include additional nozzles to spray water or any other liquid into the process of gas absorption forming an emulsified liquid solution.

The following detailed description illustrates the invention by way of example, and not by way of limitation. The description enables one skilled in the art to make and use the invention, and describes several embodiments, adaptations, variations, alternatives and uses of the invention, including what the inventors presently believe is the best mode of carrying out the invention. Various changes may be made; it is intended that the present invention and accompanying drawings be interpreted as illustrative and not a limitation.

### BRIEF DESCRIPTION OF THE DRAWINGS

FIG. 1 is a section view of one embodiment of the absorber apparatus.

FIG. 2 is an isometric view of the absorber apparatus showing a position of a liquid outlet port.

FIG. 3 is a view of a side flange with nozzles for supply of additional liquids.

FIG. 4 is a side view of the side flange.

FIG. 5 is a view of lower bar having gas-liquid solution outlet passage.

FIG. 6 is a view of one embodiment of nozzle manifold.

### DETAIL DESCRIPTION OF THE DRAWINGS

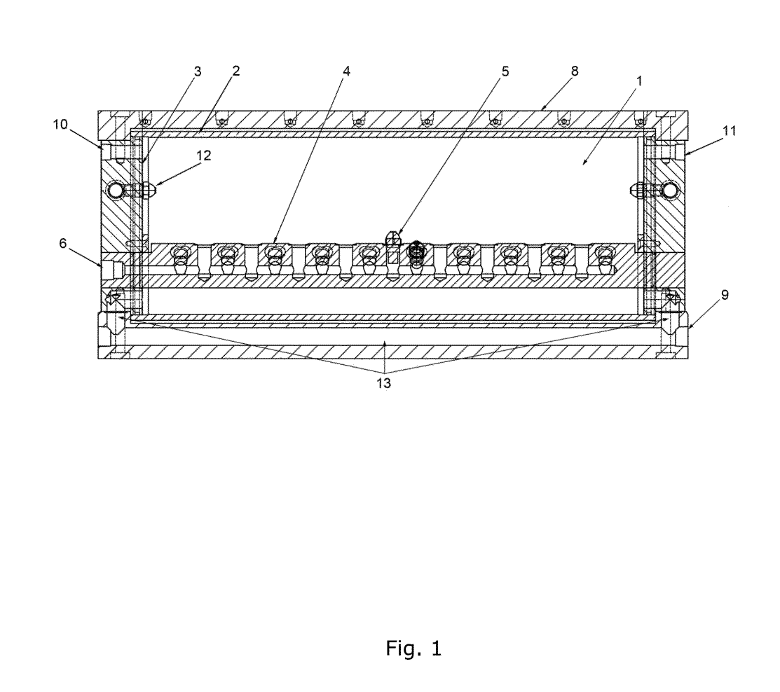

FIGS. 1-5 illustrate a preferred embodiment of the gas absorber. The preferred embodiment illustrates an exemplary design of the gas absorber of the present invention. Referring to preferred embodiment shown on FIGS. 1, gas absorber apparatus comprises a chamber 1 of tank-less continuous flow-through design; said chamber formed by a tube 2 and side flanges 3. In the preferred embodiment, flanges 3 are fixed to tube 2 with an upper bar 8 and a lower bar 9. Flanges 3 are sealed with the tube 2 and lower bar 9 using O-rings (not shown). Nozzle manifold 4 is a hollow rod having openings to fit nozzles 5 and liquid inlet port 6. Nozzle manifold 4 attaches to side flanges 3. Nozzles 5 are attached to nozzle manifold 4 and positioned in one or more rows under variable angles, preferably under 45° angles, for the purpose of uniformly distributing liquid droplets within the chamber 1 of the absorber apparatus. The number and relative position of the nozzles 5 are chosen depending on the application of the absorber apparatus.

Liquid is supplied into the chamber 1 through a nozzle manifold 4 via liquid inlet port 6 under such pressure that provides for adequate dispersion of liquid droplets by nozzles 5.

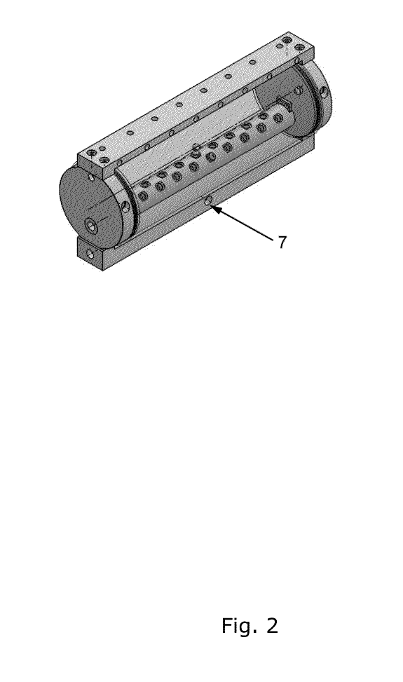

Gas is delivered through gas inlet port 10. According to the Henry's Law the solubility of a gas in a liquid is directly proportional to the partial pressure of the gas above the liquid. Accordingly, gas is supplied at the pressure sufficient to provide complete dissolution of gas in liquid, depending on physical and chemical characteristics of gas and liquid used. For example, when air is used, the air is supplied under pressure ranging from 150 to 235 psi, whereas in case of natural gas or CO₂ the gas pressures range from 90 to 120 psi. Liquid is sprayed through the nozzles 5 into a gas containing in chamber 1 under pressure. Gas saturates into dispersed liquid droplets forming a gas-liquid solution, which flows to the bottom of chamber 1 and straightway exits through a discharge passage 13 to a gas-liquid solution outlet port 7. In the described embodiment, the solution outlet port 7 is located at the lower bar 9 (FIG. 2).

As some components of a gas composition, e.g., air, dissolve in the liquid more easily than others and with time the gaseous medium become richer with poorly dissolving gas components a purging port 11 is provided for renewing gaseous medium in chamber 1. In case of automotive applications, these venting gases can be directed to an air intake of an internal combustion engine.

Another embodiment of the absorber apparatus is provided for illustration of operating with combination of liquids. In this embodiment, absorber may have additional nozzles 12 to introduce additional liquid, e.g. water. The illustrated case provides additional nozzles 12 installed into flanges 3.

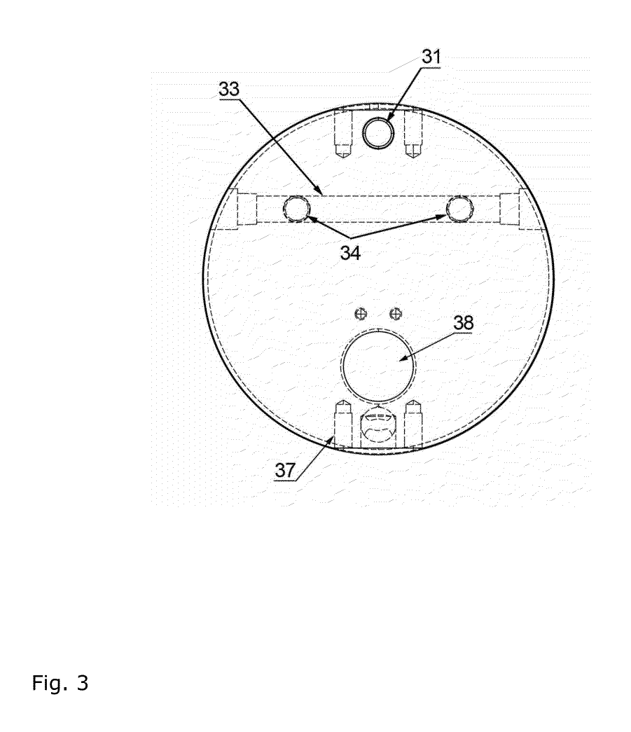

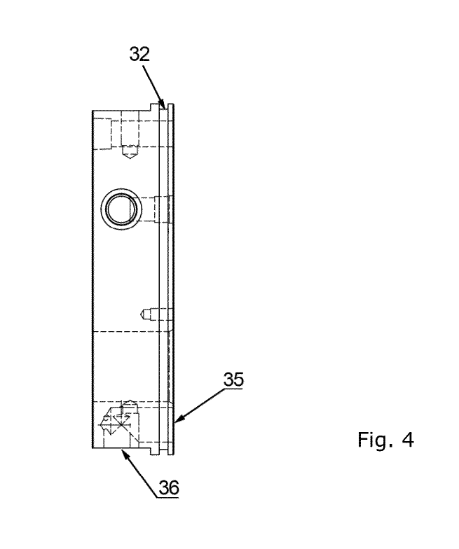

FIGS. 3 and 4 illustrate the preferred embodiment of a side flange 3. Referring to FIG. 3, the side flange 3 has a gas port 31 which can act as an inlet or outlet port feeding gas or combination of gasses into the gas absorber or venting the gas medium to renew gas composition during the process of gas absorption accordingly. Flange 3 has groove 32 for sealing O-ring when inserted into the tube 2. Flanges 3 have L-shape passage which serves to exit gas-liquid solution from absorber without accumulation. The L-shape passage has openings 35 and 36 where the opening 35 is oriented towards the inside of chamber 1, and opening 36 is oriented outside to match with the appropriate an outlet passage opening in the lower bar 9. At the top and bottom of the flanges 3 there are also two pairs of screwed holes 37 that to be matched with appropriate matching tapped holes in the upper and lower bars 8 and 9 accordingly.

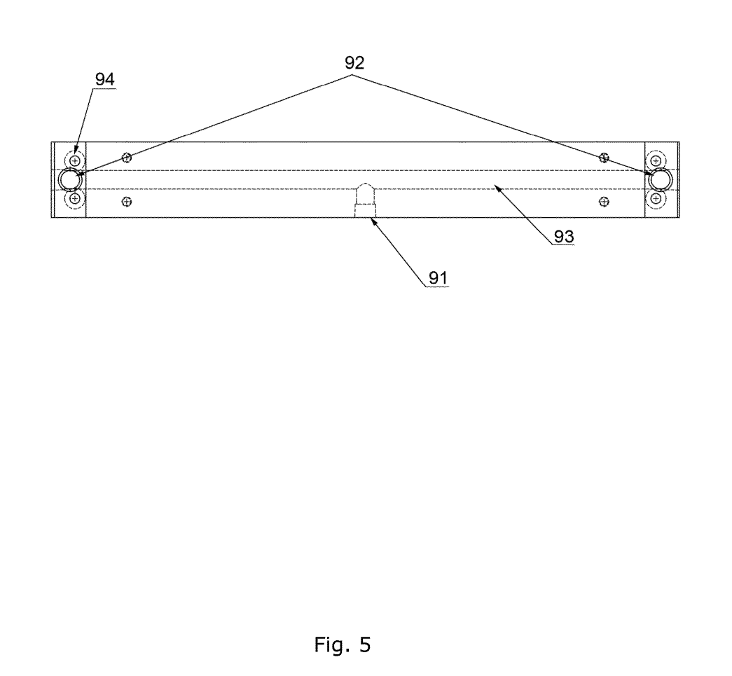

To introduce additional liquid to a process of gas absorption a channel 33 is provided in the flanges 3 with nozzles 34 and serves for spraying additional liquid, e.g. water, into chamber 1. By example, and not by limitation, adding water to the process of saturating gas into fuel allows forming emulsified fuel. FIG. 5 illustrates preferred embodiment of the lower bar 9 which has an outlet passage 93 leading to gas-liquid solution outlet port 91 (or 7 in FIG. 2). The outlet passage 93 has openings 92 in tabs 95 located at the ends of lower bar 9 to be matched with appropriate openings 36 in the flanges 3. The outlet passage 93 serves to flow gas-liquid solution from chamber 1 to prevent accumulation. Four tapped holes 94 are provided for fixing the flanges 3 in the tube 2 when assembling the absorber apparatus 1.

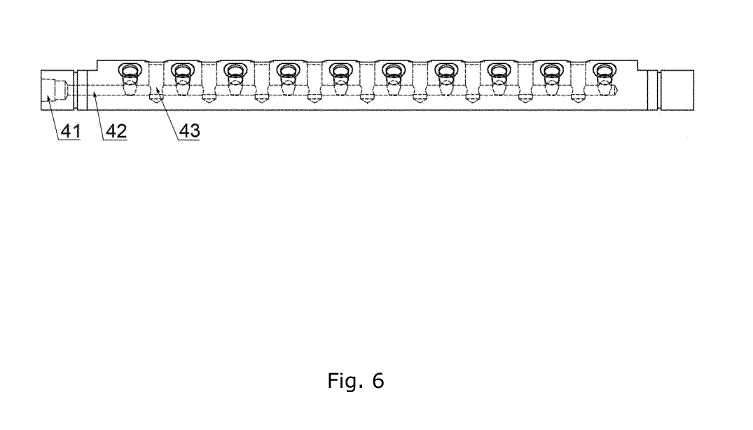

FIG. 6 illustrates a preferred embodiment of nozzle manifold 4.

Referring to FIG. 6, nozzle manifold 4 is a hollow rod which has liquid inlet port 41, a channel 42 leading to a number of openings 43 allowing installation of nozzles 5 (FIG. 1). The number and relative position of the nozzles 5 are chosen depending on the application of the absorber apparatus.

The invention may be used in any chemical process requiring saturation of gasses in liquids or in any physical process requiring atomization of a liquid or a combination of liquids for any reason. Although other embodiments are possible, the description above illustrates the preferred embodiment of using this invention in the field of internal combustion engines and saturating of gases in liquid fuels and in no way should be considered as a limitation on the present invention.

What is claimed is:

1. A method for dissolving gas in liquid comprising:
a. providing a tank-less gas absorber apparatus having a continuous flow-through chamber adapted to receive gas and liquid through separate ports; said chamber having: 1) at least one nozzle to supply at least one liquid into the chamber; 2) at least one gas inlet to supply at least one gas into the chamber; and 3) at least one outlet to deplete gas-liquid solution from the chamber;
b. supplying at least one gas into said chamber;
c. supplying at least one liquid into said chamber;
d. dissolving gas in liquid under pressure forming gas-liquid solution; and
e. depleting gas-liquid solution from the chamber via continuous flow during the process of forming gas-liquid solution wherein the gas-liquid solution does not accumulate in the chamber.

2. The method of claim 1 further comprising supplying at least one liquid into the chamber through nozzles.

3. The method of claim 1 further comprising supplying additional liquids into the chamber through additional channels.

4. The method of claim 1 further comprising creation of high surface contact area of dispersed liquid droplets with gas.

5. The method of claim 1 further comprising combustible gaseous medium inside the chamber and periodically purging said medium from the chamber.

6. The method of claim 1 further comprising introduction of additional liquids into the chamber during the process of forming gas-liquid solution through one or more additional nozzles.

7. A tank-less gas absorber apparatus for dissolving gas in liquid comprising a continuous flow-through chamber adapted to receive gas and liquid through separate ports; said chamber having:
a. at least one nozzle to supply at least one liquid into the chamber;
b. at least one gas inlet to supply at least one gas into the chamber; and
c. at least one outlet to deplete gas-liquid solution from the chamber;
wherein the gas-liquid solution does not accumulate in the absorber.

8. The apparatus of claim 7 further comprising side flanges adapted to have gas and liquid inlets.

9. The apparatus of claim 8 further comprising side flanges adapted to have gas and liquid outlets.

10. The apparatus of claim 8 further comprising nozzle manifold adapted to disperse liquid droplets into the chamber.

11. The apparatus of claim 8 further comprising at least one purging outlet for venting and renewing gas medium from the chamber.
